(19) United States
(12) Patent Application Publication
(10) Pub. No.: US 2026/0353434 A1
(43) Pub. Date: Nov. 5, 2026

(54) CONFIGURATION FOR PRIORITY OF GAP

(71) Applicant: APPLE INC., Cupertino, CA (US)

(72) Inventors: Qiming Li, Beijing (CN); Yang Tang, San Jose, CA (US); Manasa Raghavan, Sunnyvale, CA (US); Dawei Zhang, Saratoga, CA (US); Yuexia Song, Beijing (CN); Jie Cui, San Jose, CA (US); Xiang Chen, Beijing (CN); Rolando E Bettancourt Ortega, Munich (DE)

(21) Appl. No.: 19/107,696

(22) PCT Filed: Sep. 23, 2022
(86) PCT No.: PCT/CN2022/120871

§ 371 Date: Feb. 28, 2025

(51) Int. Cl. H04W 72/566; H04W 8/18

(52) U.S. Cl. CPC H04W 72/569; H04W 8/183

(57) ABSTRACT

The present disclosure relates to configuration for priority of gap. There provides a wireless device, comprising: at least one antenna; at least one radio coupled to the at least one antenna; and a processor coupled to the at least one radio; wherein the processor is configured to: acquire a gap configuration scheduling operation of the wireless device in accordance with gap patterns, wherein the gap configuration includes priority information related to a priority for each of multiple gap patterns, and perform operation based on the gap patterns, wherein the operation is performed based on the priorities of the gap patterns

### TECHNICAL FIELD

This application generally relates to wireless communication, including configuration for priority of gaps in the wireless communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to apparatuses, systems, and methods to provide improved gap priority configuration and associated operation, particularly improved gap priority configuration for MUSIM, and/or dynamic updating of gap priorities.

According to techniques described herein, a network-side device may provide a gap configuration to a wireless device, the gap configuration scheduling operation of the wireless device in accordance with gap patterns, and particularly, the gap configuration may define priority information for at least two gaps which may belong to the same or different types and some of which may be overlapped with each other in time domain. Accordingly, the wireless device may perform operation based on the gap patterns as scheduled. In particular, in case of collision between at least two gap occasions, the wireless device can perform operation in the occasion of the gap with highest priority.

In one aspect, an improved gap configuration including priority information may be particularly applied to MUSIM case. In another aspect, in a gap configuration, the priority for at least one gap can be dynamically changed, particularly based on at least one specific event or status related to the gap.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

A better understanding of the present subject matter can be obtained when the following detailed description of various embodiments is considered in conjunction with the following drawings, in which:

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 is a flowchart diagram illustrating an example method at the wireless device side according to some embodiments of the present disclosure.

FIG. 4 is a flowchart diagram illustrating an example method at the network device side according to some embodiments of the present disclosure.

FIG. 5 schematically illustrates exemplary operations at the wireless device side according to some embodiments of the present disclosure.

FIG. 6 schematically illustrates exemplary operations at the network device side according to some embodiments of the present disclosure.

FIG. 7 is a schematic diagram illustrating signaling between the network device side and wireless device side according to some embodiments of the present disclosure.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims

### DETAILED DESCRIPTION

To easily identify the discussion of any particular element or act, the most significant digit or digits in a reference number refer to the figure number in which that element is first introduced.

### TERMS

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system. As an example, the base station may be, for example, an eNB in a 4G communication standard, a gNB in a 5G communication standard, a remote radio head, a wireless access point, an unmanned aerial vehicle control tower, or a communication device that performs similar functions.

Network Device—any of various types of computer systems or devices that perform communications, particularly perform wireless communication with the wireless device, such as downlink communication to the wireless device related to downlink transmission. The network device can be portable (or mobile) or may be stationary or fixed at a certain location. A base station is an example of a network device.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

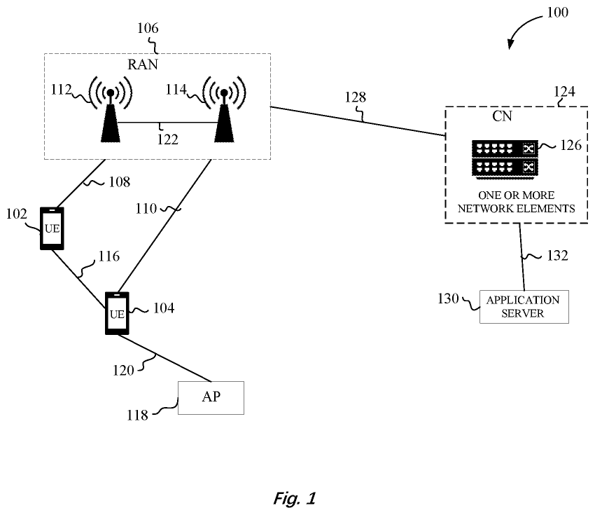

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

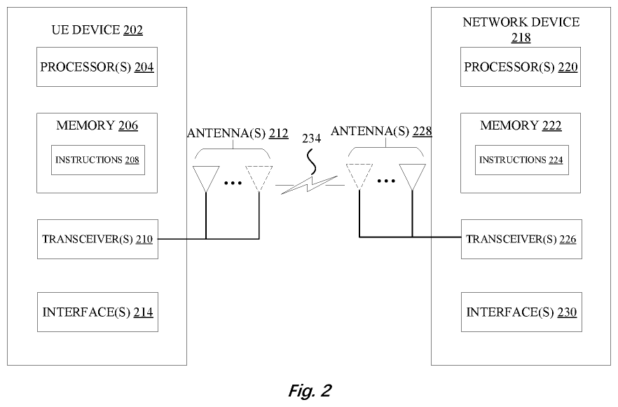

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may be used for various aspects of the present disclosure, particularly acquire gap configuration, particularly including gap priority information, and/or performing operation in accordance with the gap configuration, particularly based on the gap priority information. Such operation/functionality can be implemented via hardware, software, or combinations thereof. For example, such operation/functionality can be performed by means of a specific component incorporated in the wireless device, for example, a processor, circuit, which can be integrated within the processor(s) 204 and/or the transceiver(s) 210, and/or can be performed by means of software, such as instructions 208 stored in the memory 206 and executed by the processor(s) 204. In particular, such functionality can be implemented by a combination of software components (e.g., executed by a DSP or a general processor) and hardware components (e.g., logic gates and circuitry) within the processor(s) 204 or the transceiver(s) 210. Some embodiments of such operation/functionality will be described below in detail with reference to figures.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may be used for various aspects of the present disclosure, particularly acquire or configure appropriate gap configuration, particularly including gap priority information, and/or provides the gap configuration to the wireless devices so that the wireless device can perform operation in accordance with the gap configuration, particularly based on the gap priority information. Such operation/functionality can be implemented via hardware, software, or combinations thereof. For example, such operation/functionality can be performed by means a specific component incorporated in the wireless device, for example, a processor, circuit, which can be integrated within the processor(s) 220 and/or the transceiver(s) 226, and/or can be performed by means of software, such as instructions 224 stored in the memory 222 and executed by the processor(s) 220. In particular, such functionality can be implemented by a combination of software components (e.g., executed by a DSP or a general processor) and hardware components (e.g., logic gates and circuitry) within the processor(s) 220 or the transceiver(s) 226. Some embodiments of such operation/functionality will be described below in detail with reference to figures.

Wireless communication techniques are continually under development, to increase coverage, to better serve the range of demands and use cases, and for a variety of other reasons.

New cellular communication techniques are continually under development, to increase coverage, to better serve the range of demands and use cases, and for a variety of other reasons. One technique that is currently under development may include enhancement of measurement operation by means of measurement gap. As part of such development, it would be useful to provide improved measurement gap configuration and related operation.

Specifically, in wireless communication, when it is required to perform measurement operation for a specific signal/parameter/indicator which may be for example, performance related, particularly a case that such measurement operation shall be performed at a different frequency point, to deal with possible inter-frequency measurement, Measurement Gap is utilized. The idea of Measurement Gap is to create a small gap, during which neither transmission nor reception occurs, thus, the wireless device can perform the corresponding measurement operation in the Measurement Gap and then switch back.

The measurement gap operation may include any kinds of measurement operation which can be performed by means of measurement gap or any other kind of gap/interruption. For example, the measurement operation can be performed during any appropriate kinds of wireless communication operation, including such as cell switch and/or access, Carrier Aggregation including at least carrier switching and management, load aggregation, etc., at any appropriate phase/stage during the wireless communication, including such as initialization, status transition, etc., and can be utilized to measure any desired signal/parameter/indicator which may be for example, performance related, including such as SSB, PRS, etc.

In the present disclosure, the measurement operation can be performed at any appropriate working frequency segment based on corresponding measurement gap configuration, for example, performed based on measurement gap pattern(s) corresponding to the working frequency segment. According to some embodiments, the working frequency segment may be set in accordance with the working frequency level of the wireless communication, and particularly, the level can be selected from a group including UE level, frequency range level, band combination level, band level, Component Carrier (CC) level, Bandwidth Part (BWP) level.

The wireless device can be configured with multiple measurement gaps, which, for example, may include periodic gaps and/or aperiodic gaps. In some examples, a wireless device can be configured with two concurrent gaps. In some other examples, for a case of Multiple Universal Subscriber Identity Module (MUSIM) wireless communication, the wireless device can be configured with no more than three periodic MUSIM gap patterns and/or one aperiodic MUSIM gap pattern for MUSIM. Note that the number of gaps as described above are only exemplary, and are not so limited.

When multiple gaps are configured, it is possible that some gap occasions from different gap patterns are overlapped with each other in time domain, and such gap overlapping may cause operation collision to some extent.

However, how to handle collision hasn't been specified if UE is configured with MUSIM gap(s). Therefore, it is still desired to improve the configuration for MUSIM gaps to enhance operations in the MUSIM case.

Besides, in concurrent gaps design, the priority information may be predefined or set, such as during initialization or specific time, and may be kept unchanged. However, as the wireless communication proceeds, the priority of a gap may not match the status or condition related to operation to be performed at the gap, so that a desired operation which may be more critical, cannot be performed timely. For example, in a case that the operation corresponding to a gap is more urgent to be performed but such gap is still with a low priority, when collision between two measurement gap occasions occurs, operation corresponding to such urgent gap cannot be performed timely. Therefore, it could be beneficial to introduce an improved solution to achieve dynamic updating of priority of gap.

Moreover, the priority information may be set and provided by the network device to the wireless device such as via RRC reconfiguration. However, RRC procedure would take quite a long time (up to hundreds of ms), and the priority of measurement gap cannot be updated timely so that the associated operation may be low efficient. Particularly, the collision cannot be handled efficiently. Therefore, it could be beneficial to introduce some dynamic solution to achieve timely update of priority of gap.

Hereinafter some embodiments will be described with reference to figures. Wherein, the description may be mainly based on a specific type of gap, that is, measurement gap, however, the description and thereby the concept of the present disclosure can be equivalent to any other appropriate type of gaps.

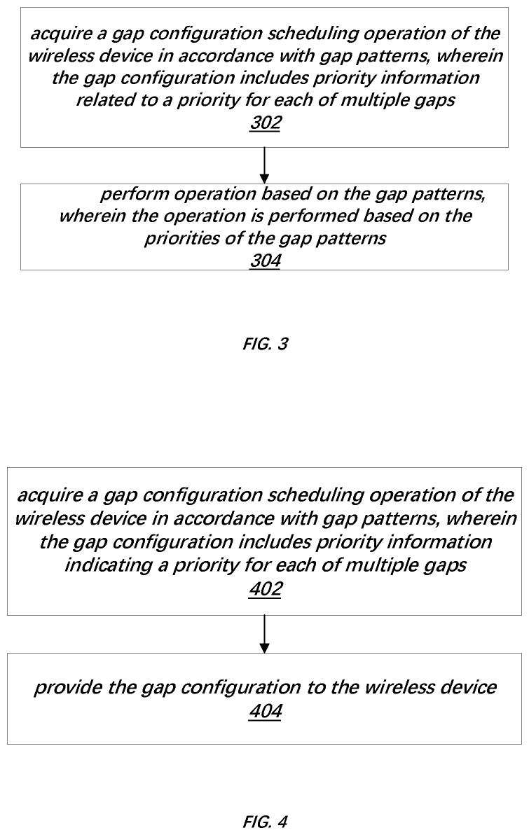

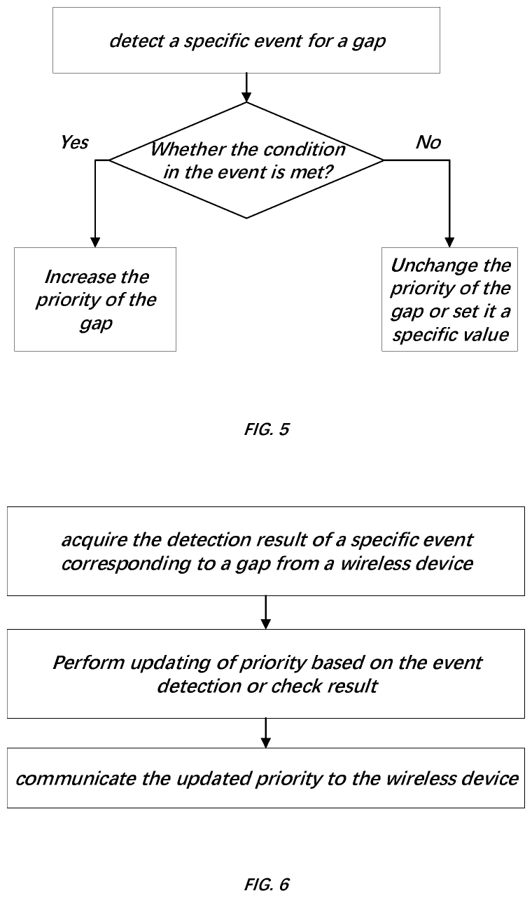

FIGS. 3 and 4 are flowchart of methods at the wireless device and FIGS. 5-6 illustrate further aspects that might be used in conjunction with the method of FIGS. 3 and 4 if desired. It should be noted, however, that the exemplary details illustrated in and described with respect to FIGS. 5-6 are not intended to be limiting to the disclosure as a whole: numerous variations and alternatives to the details provided herein below are possible and should be considered within the scope of the disclosure.

FIG. 3 illustrates a flowchart illustrating an example method at the wireless device side at least according to some embodiments. Aspects of the method of FIG. 3 may be implemented by a wireless device such as a UE 106 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 3 may operate as follows.

At step 302, the wireless device acquires a gap configuration scheduling operation of the wireless device in accordance with gap patterns, wherein the gap configuration includes priority information related to a priority for each of multiple gaps.

According to some embodiments, the gap configuration can include information related to gap pattern. In some embodiments, a gap pattern may indicate the characteristic of a type of gap which can be utilized for performing specific operation. In particular, the gap pattern can have corresponding gap characteristics, including at least one of gap identity, time duration and periodicity of the gap, start and end of the gap, the frequency segment in which the gap is located, the operation or object in accordance with the gap pattern, etc., Usually, “gap configuration” and “gap pattern” may be equivalent to some extent, and particularly can be used interchangeably for a single gap. In particular, when there exist multiple gaps, each gap may have a corresponding gap pattern, which also can be referred to a gap configuration for the gap. On the other hand, all gap patterns can constitute a whole gap pattern, which may correspond to a whole gap configuration for the wireless device.

According to some embodiments, priority can be set for a gap. In other words, the priority for a gap can be referred to as priority for the gap pattern corresponding to the gap, which may actually indicate the priority for performing operation to be performed at the gap when the gap collides with other gaps. In an embodiment, each gap or gap pattern can have its corresponding priority. In the context, “priority of gap” can be used interchangeably with “priority of gap pattern”. For example, in case of collision between two gap occasions, the operation related to the gap with higher priority will be performed, while operations of other gaps will not be performed at time.

According to some embodiments, “operation related to a gap” or “operation for a gap” may mean an operation intended to be performed in the occasion of the gap, such as in the duration and period of the gap. Therefore, in a sense, “gap” and “gap occasion” are equivalent to some extent and can be used interchangeably.

In some embodiments, the priority can be given by any appropriate presentation, such as a positive numerical value, wherein the larger the value is, the higher the priority is. Of course, any other appropriate presentation or expression can be utilized to indicate the priority, as known in the art, and will not be described in detail herein.

According to some embodiments, information about priority of gap can be associated with the gap pattern or gap configuration, such as, incorporated into the gap pattern of gap configuration of the gap, for example, constituting an item in the gap pattern or gap configuration, or can be outside of the gap pattern or gap configuration and associated therewith in any appropriate manner.

By taking R17 case as an example, an exemplary gap configuration can be as follows, such as that in R17.

| GapConfig-r17 ::= | SEQUENCE { | |
|---|---|---|
| measGapId-r17 | MeasGapId-r17, | |
| gapType-r17 | ENUMERATED (perUE, perFR1, perFR2), | |
| gapOffset-r17 | INTEGER (0..159), | |
| mgl-r17 | ENUMERATED {ms1, ms1dot5, ms2, ms3, ms3dot5, ms4, ms5, ms5dot5, ms6, ms10, ms20}, | |
| mgrp-r17 | ENUMERATED {ms20, ms40, ms160}, | |
| mg [symbol] -r17 | ENUMERATED {ms0, ms0dot25, ms0dot5, ms0dot75}, | |
| refServCellIndicator-r17 | ENUMERATED {pCell, pSCell, mcg-FR2} | OPTIONAL, -- [symbol] |
| ref [symbol] -ServCellAsyncCA-r17 | ServCellIndex | OPTIONAL, -- [symbol] |
| preConfigInd-r17 | ENUMERATED {true} | OPTIONAL, -- Need R |
| [symbol] Ind-r17 | ENUMERATED {true} | OPTIONAL, -- Need R |
| gapAssociationPRS-r17 | ENUMERATED {true} | OPTIONAL, -- Need R |
| gapSharing-r17 | MeasGapSharingScheme | OPTIONAL, -- Need R |
| | GapPriority-r17 | OPTIONAL, -- Need R |

...
} [symbol]
indicates data missing or illegible when filed

Note that the above example may mean a gap configuration for a single gap, may be referred as gap pattern for the gap, and for such a single gap, its priority item/information is indicated as “gapPriority-r17”, and the corresponding contents/setting/attributes for the priority information are set/indicated in the corresponding field “GapPriority-r17”. Of course, the gap configuration can further include other information/attribute related to the gap, such as gap ID (measGapId-r17), gap type (gapType-r17), time and/or frequency attribute of the gap, such as time duration, period, frequency segment, etc., which can be known in the art, and will not be described in detail herein.

Accordingly, when there exist multiple gaps, there may exist multiple gap configurations correspondingly, that is, the number of priority configuration can be same as the number of the multiple gaps, each gap has a corresponding gap configuration, such as discussed above, and respective gap configurations can have similar or different form/items. For example, each gap configuration may also include priority item, and alternatively, the configurations for some gaps may have priority items, while the configurations for other gaps may have no priority item.

In some embodiments, when there exist multiple gaps and a whole gap configuration constituted by respective gap patterns can be set, the priorities of respective gaps can be included in the whole gap configuration in any appropriate manner, such as a list, a table, a map, etc. which indicates gap ID and its corresponding priority, instead of incorporated into gap pattern or configuration of each gap. In some embodiments, the gap priority can be included in other information than the gap pattern or gap configuration, particularly the whole gap configuration, and the association between the priority and the gap pattern can be transmitted via other signaling or information at any appropriate timing.

The above exemplary gap configuration specifically defines the characteristic of gaps, and when there exist multiple gaps, the gap configuration may specifically define the characteristic of respective gaps. Of course, the gap configuration for multiple gaps can be in any other appropriate form/format.

For example, the gap configuration may include gap pattern index/indicator indicating a gap pattern, and based on the gap pattern index/indicator, the gap characteristic of gap pattern can be directly derived. In such a case, the gap configuration can indicate association/mapping between the measurement gap pattern index/indicator and working frequency segment index/indicator. And the wireless device when receiving the gap pattern index/indicator, can obtain the gap characteristic of gap pattern locally or from other appropriate party.

According to the present disclosure, the wireless device can acquire the gap configuration in a variety of manners. According to some embodiments, the gap configuration per se can be acquired from any appropriate party, such as the network-side device, a controlling device in a wireless communication system, a TRP, and so on. According to some embodiments, the gap configuration can be derived by the wireless device per se, for example, the wireless device can obtain any appropriate information indicating the gap configuration, such as index of gap configuration, other information available for deriving the configuration, etc., and the wireless device can derive the configuration based on the information, such as by look-upping table.

At step 304, the wireless device performs operation based on the gap configuration, wherein the operation is performed based on the priorities of gaps indicted in the gap configuration.

In particular, the wireless device can perform operations based on the gap configuration may means that the operation can be performed based on gap patterns or characteristic of gaps indicated in the gap configuration. For a gap, the corresponding gap pattern may mean characteristics of the gap, such as time duration, period, frequency attributes, and so on. For example, for a gap, a corresponding operation can be performed in accordance with the period of the gap, and particularly, in the duration of occasion of the gap.

According to some embodiments, the operation for a gap may comprise a kind of operation depending on the type or characteristic of the gap. In particular, depending on the types of the gaps, the operation performed in the gaps may be different from each other. For example, for a measurement gap, a measurement operation will be predetermined, such as the measurement object will be predetermined, and such measurement operation will perform in accordance with the measurement gap pattern. In addition to a measurement gap, other types of gaps may include Pre-configured measurement gap (Pre-MG), Network controlled small gap (NCSG), Gap for Non-Terrestrial Network (NTN gap), Gap for positioning (PosGap), and for each type of gap, corresponding operation can be predefined and performed in the gap occasion.

According to some embodiments, when at least two of the multiple gaps collide, the wireless device can perform operation based on the gap configuration/pattern of a gap in the at least two gaps with the highest priority. For example, in case of collision between two measurement gap occasions, the UE shall perform measurements in the occasion of the measurement gap with higher priority, and the occasion of the measurement gap with lower priority shall be dropped.

According to some embodiments, the priority of a gap can be set/defined in any appropriate manner. In some embodiments, the priority value of a gap can be initialized or predetermined at the start of the wireless communication, such as set as a predetermined value, such as zero, or empirical value, such as weight or importance of the operation corresponding to the gap, and/or the priority value of the gap can be kept unchanged, or updated, during the communication.

According to some embodiments, the priority of a gap can be updated based on specific status or event related to the gap, particularly, specific status or event related to the operation to be performed for the gap. In particular, the status or event may relate to triggering of the operation to be performed for a gap, and can reflect the possibility that the operation is intended to be triggered to some extent. Therefore, when the status or event indicates the operation is more likely to be performed, such as it is judged that the condition of the status or event is met, the priority for the gap shall be higher so than when there occurs gap collision, the operation for the gap would be prioritized, while when the status or event indicates the operation is less likely to be performed, the priority for the gap shall be unchanged or lower, so than when there occurs gap collision, the operation for the gap can be relatively postponed. And similarly, an event related to a gap may be equivalent to an event related to a gap pattern, and can be used interchangeably.

According to some embodiments, information about an event related to a gap can be associated with the gap pattern or gap configuration, such as, incorporated into the gap pattern of gap configuration of the gap, for example, constituting an item in the gap pattern or gap configuration, or can be outside of the gap pattern or gap configuration and associated therewith in any appropriate manner, which may be similar with that for priority information described above and thus is not described here.

Note that the specific status or event for the gap can be appropriately preset, such as set in consideration the characteristic of operation for the gap, set in the initialization of the system, set empirically, and so on. For example, UE can be configured with a MUSIM gap which is used for RRM measurement on NW B, and the status or event related to such gap may include UE location, UE movement status, etc., and when it is checked that UE is quite stationary and in the cell center, the first gap for RRM measurement can be considered as low priority since it is unlikely for UE to trigger handover. But when UE is moving to the cell edge, high priority for the first gap needs to be considered.

According to some embodiments, for updating of priority, the specific status or event can be checked or detected so as to judge whether the check or detection result met some specific condition, and when the condition is met, the priority can be updated accordingly, for example, increased, unchanged, or decreased. In an example, the check or detection result can be compared with a specific threshold, and when the check or detection result is beyond the threshold, which may mean the possibility of triggering the operation is higher, the priority can set as a higher priory, such as set as a higher value corresponding to the threshold, or increased from a previous value, otherwise, the priority can be unchanged or set as a lower priority, such as set as a lower value corresponding to the threshold, or decreased from a previous value.

According to some embodiments, the priority of a gap can be defined in a predetermined range and can be updated step by step. In particular, for the priority of a gap, there may predefine a specific range between a minimum value and a maximum value, including the minimum value and the maximum value, with several values interposed therebetween at a specific interval, the interval may correspond to the step, so that during the updating of priority, the priority can be increased or decreased by the step. For example, the priority of gap can be in 0-15, and can be updated by increasing 1 or decreasing 1 at each time.

In some embodiments, the above threshold for updating the priority can be set in any appropriate manner. In an example, there may exist one single threshold for an event. In another example, there may exit at least two thresholds for an event, and the priority can be accordingly set with respect to each threshold, particularly based on comparison with respective thresholds. For example, for an event, N thresholds, from lowest to highest can be set for the event, N is an integral more than one, and thus (N+1) sub-priorities can be set for the event, wherein when lower than the lowest threshold, interposed between any two adjacent thresholds, or higher than the highest threshold, a corresponding priority can be set.

According to some embodiments, the priority of a gap can be set in consideration of specific events corresponding to the gap. In particular, when at least one event may correspond to the gap, so that the priority of gap can be set or updated based on status or condition of each of the at least one event. In some embodiment, when a gap has one corresponding event, the priority of gap can also be updated based on check or detection of the event. In some other embodiments, when a gap has at least two corresponding events, for each event, a corresponding priority value (can be referred to priory for event, or a sub-priority) can be updated based on check or detection of the event, and then the priority of gap can be obtained by combining updated priorities for all events, particularly statistic values of sub-priorities of respective events, such as sum of sub-priorities of respective events. Note that the updating of sub-priority for an event can be performed in any appropriate manner, such as that discussed above. In particular, the threshold for updating of sub-priority for an event can be one single threshold, or at least two thresholds, and thus the sub-priority for the event can be updated in any appropriate manner, such as that discussed above. For example, there may exist at least one events for a gap, such as N events, and for each event, there may exist M sub-priority available, therefore, the priority of the gap can be set or defined from N×M priorities, each corresponding to summing of respective sub-priority of each event, between minimum value (corresponding to summing of minimum sub-priority of each event) and maximum value (corresponding to summing of maximum sub-priority of each event).

According to some embodiment, the updating of priority can be performed in any appropriate manner. In particular, the updating of priority can be performed periodically or upon request, and/or, the check or detection of status or event can be performed periodically or upon request. In some embodiments, the period for updating of priority can be the same as or different from the period of gap. And when their periods are the same, the priority can be first updated and then for at least two gaps colliding, the gap with highest priority can be applied. And when their periods are different, the priority of gaps can be updated and stored temporarily and utilized for the gaps. In some other embodiments, the check or detection of status or event can be performed in a period which may be the same as that of updating of priority and/or gap, or can be different from each of updating of priority and/or gap. For example, the check or detection of status or event can be performed and then the check or detection result can be stored temporarily, and then can be utilized in the updating for priority, and then the updated priority can be utilized for the gap pattern, particularly the operation to be performed in the occasion of the gap.

According to some embodiments, the updating of priority can be performed by any appropriate entity in the system. In some embodiments, the wireless device can perform dynamically updating of priority of a gap in the multiple gaps based on detection result of a specific event corresponding to the gap, so that in operation, the priority can be timely updated and the operation can be performed more efficiently. In particular, in some embodiments, the wireless device can detect a specific status or event corresponding to a gap in the multiple gaps, and dynamically update the priority of the gap when it is detected that condition in the specific event is met. On the other hand, when it is detected that the condition in the specific event is not met, set the priority of the gap to a specific priority value or do not change the priority of the gap, wherein the specific priority value is a default priority value or the previous priority value. FIG. 5 exemplarily illustrates updating of priority of gap, such as particularly at the wireless side.

According to some embodiments, optionally, the updated priory of gap, as obtained in any appropriate manner, such as discussed above, can be provided by the wireless device to any other appropriate entity in the system, particularly the network device in the system.

Thus, the method of FIG. 3 may be used by a wireless device to perform improved gap priority configuration and/or updating, at least according to some embodiments.

FIG. 4 illustrates a flowchart illustrating an example method at the network device side at least according to some embodiments. Aspects of the method of FIG. 4 may be implemented by a network-side device for example a base station such as a BS 102 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 4 may operate as follows.

At step 402, the network device acquires a gap configuration scheduling operation of the wireless device in accordance with gap patterns, wherein the gap configuration includes priority information related to a priority for each of multiple gaps.

According to some embodiments, the gap configuration can be generated/established by any appropriate device in the wireless communication system. In an embodiment, the gap configuration can be generated/established by the network device itself, and in another embodiment, the gap configuration can be generated/established by any appropriate device in the system and then provided to the network device, periodically or upon request from the network device.

According to some embodiments, the gap configuration can be in any appropriate form or format, and particularly, when there may exist multiple gaps, the gap configuration may include information related to each gap, including basic gap information and its priority information, as described above.

According to some embodiments, the network device can configure events and corresponding gap priorities for the multiple gaps in the gap configuration. In some embodiments, such gap configuration can be in any appropriate form, such as a list, table, etc., and wherein, for each gap, items indicating its associated events and corresponding priority, including but not limited to the priorities corresponding to each event or the priority corresponding to the gap, can be incorporated in the gap configuration, as described above. For example, when there exist two or more events associated with a gap, the priority for such a gap can include sub-priorities for each event, so that the priority for such a gap can be calculated therefrom, as discussed above. In another example, only the priority for such a gap can be incorporated into the gap configuration, and can be calculated as discussed above. In yet another example, for a gap, both the priorities for associated events and the priority for the gap can be incorporated into the gap configuration.

According to some embodiments, the updating of priority can be performed at the network device side. For example, the network device can acquire detection result of a specific event corresponding to the gap, such as from the wireless device or other appropriate entity, and then perform dynamically updating of priority of a gap in the multiple gaps based thereon, and then provide the updated priority to the wireless device. The manner of updating of priority can be performed in a manner as discussed above, and thus will not described here. FIG. 6 exemplarily illustrates updating of priority of gap, such as particularly at the network side device.

At step 404, the network-side device may provide the gap configuration information to the wireless device, so that the wireless device can perform operations based on the gap configuration information.

In some embodiments, the network device can acquire, particularly generate, gap configuration including initial priorities of gaps, and then provide the gap configuration to the wireless device. In some embodiments, when the priorities of gaps can be updated, the network device can acquire the updated priorities of gaps. In some embodiments, the updated priorities of gaps can be obtained at the wireless device side and then provided to the network device. On one hand, the wireless device can perform operations corresponding to a gap in the occasion of the gap in accordance with the gap configuration, and on the other hand, the wireless device can further update the priority of gap in the gap configuration information, as described above. In some embodiments, the priorities of gaps can be updated at the network device side.

Thus, the method of FIG. 4 may be used by a network-side device, such as a base station, to schedule an improved gap configuration and related operation, at least according to some embodiments.

Hereinafter some exemplary embodiments according to the present disclosure will be described, where the exemplary embodiments relate to gap configuration and related operations, including such as gap priority updating. Note that the exemplary embodiments are described mainly based on measurement gap, but such description is not limitative, and the concept of the present disclosure can be equivalently utilized to other types of gaps.

### First Embodiment

Hereinafter, the first embodiment according to the present disclosure will be described, and in this embodiment, an improved gap configuration is especially provided for a MUSIM case. In particular, a priority information is set, particularly newly incorporated into, the gap configuration for the MUSIM gap configuration.

For example, the improved MUSIM gap configuration may be as follows:

| | |
|---|---|
| MUSIM-Gap-r18 ::= | SEQUENCE { |

| | |
|---|---|
| musim-Gap-R18 | MUSIM-Gap-r17, |
| musim-GapPriority-r18 | GapPriority-r17 |

| } | |
|---|---|
| MUSIM-Gap-r17 ::= | SEQUENCE { |

| | |
|---|---|
| musim-GapID-r17 | MUSIM-GapID-r17, |
| musim-Gapinfo-r17 | MUSIM-GapInfo-r17 |

}

where, MUSIM-Gap-r18 is an exemplary gap configuration for a MUSIM case, wherein a priory information, namely musim-GapPriority-r18, is newly incorporated in the gap configuration according to the present disclosure.

According to some embodiments, the priority information musim-GapPriority-r18 can be any appropriate format or form. In an example, it can have the same format or form as that of configuration parameter GapPriority-r17 which has been specified or set in the R17. In particular, when there may exist at least two gaps available, the parameter GapPriority-r17 may include parameters for each gap, and parameters for each gap may include a number of parameters, such as gap ID, gap priority level, etc.

Note that except the newly incorporated priority information musim-GapPriority-r18, the other information included in the MUSIM gap configuration may be the same as or similar with the information in the conventional gap configuration, such as musim-Gap-R18 may be MUSIM-Gap-r17 as that in R17, which may include any appropriate information, for example, musim-GapIN-r17 indicating Gap ID, musim-Gapinfo-r17 indicating or comprising gap information as shown in the above table 1.

In an example, the MUSIM-Gap-r18 can be a configuration corresponding to a gap, and thus when there may exist at least two gaps, there may exist at least two corresponding MUSIM-Gap-r18, which can collectively constitute a whole gap configuration for the MUSIM gaps.

Therefore, by means of such new configuration related to priority for MUSIM case, the priority for each of two or more MUSIM gaps can be appropriately set so that in communication, particularly when the gaps collide, such as operations related to gaps, can be performed in consideration of the gap priority. More specifically, such a gap configuration may include priority information related to each of at least two MUSIM gaps for the MUSIM case, so that in case of collision between at least two MUSIM gap occasions, the wireless device can perform operation in the occasion of the gap with highest priority. Therefore, the MUSIM gap configuration and related operation can be improved.

Hereinafter, the second embodiment according to the present disclosure will be described. In such an embodiment, the priority for each gap can be dynamically updated. Although in this embodiment, the updating of priority is described by taking MUSIM gaps as an example, such updating can be equivalently applied to any types of gaps.

In particular, the updating of gap priority can be performed in consideration of any appropriate factors, particularly at least one specific status or event related to the gap, as discussed above, such as at least one specific event associated with the operation to be performed for the gap. In an example, the updating of gap priority can be based on event detection, which can be referred to as the updating of gap priority being triggered by event. More specifically, a specific event is detected, and it will be judged whether the priority of a gap corresponding to the event will be updated, such as increased or decreased, based on the event detection result. In particular, when the detection result indicates the operation is more likely to be perform, the priority can be increased, and when the detection result indicates the operation is less likely to be performed, the priority can be decreased or unchanged, as described above.

The event detection result can be any appropriate form. In one example, the detection result can be the direct detection result per se, such as performance parameters or objects obtained by detecting the event related to the gap, and will be compared with a corresponding threshold. In particular, when the event detection result is beyond a threshold, it can be judged that the corresponding gap priority shall be changed. And when the detected event is not beyond the threshold, the corresponding gap priority will not be changed, or changed to a predetermined value, such as a default value, or previous value. In some other examples, the detection result can be a kind of indirect result, particularly an indicator obtained by comparing the detected event objects or parameters and the threshold. Particularly, such detection result may correspond to comparison result between the detection result and the predefined threshold, for example, an indicator or information about whether the event result is larger than the threshold.

According to some embodiments, the events related to gap can be a variety of events. For example, an event could be at least one of the following:
A measurement configuration with a measurement result threshold.
Qin and/or Qout threshold in RLM and/or BFD
low Mobility Evaluation, such as that as defined in TS38.331
cell Edge Evaluation, such as that as defined in TS38.331

Note that the above exemplary events are only exemplary, and more or less events related to triggering of the operation for a gap are possible, and can be detected or checked for updating of the priority of the gap, in any appropriate manner, such as that as discussed above.

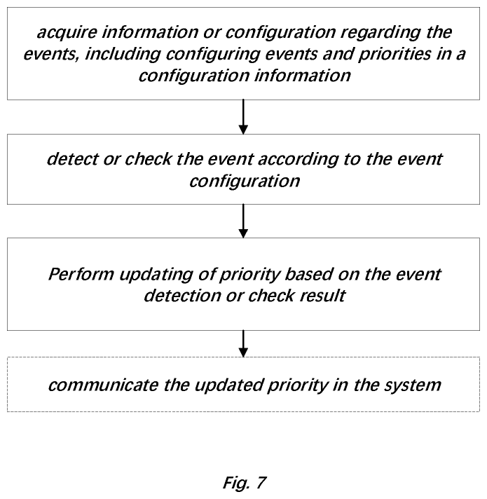

Hereinafter a process of updating the priority of gap based on event detection will be described with reference to FIG. 7, which is a flowchart illustrating such a process.

Firstly, the information or configuration regarding the events can be acquired.

In particular, the events can be configured in any appropriate manner. In particular, the events can be configured during the initialization of the system or can be confirmed during the communication periodically or upon request. And the configured events can be configured by any appropriate device in the system, particularly by the network device, such as base station, or by the wireless device, such as UE, or even by any other related device in the system.

In particular, the event can be incorporated by the network side device into related configuration information in associated with or in correspondence with the gap priority, and then can be provided to the wireless device. For example, NW configures an event and corresponding gap priority in MUSIM-GapConfig, and then transmit the MUSIM-GapConfig to UE. The gap configuration may be as follows.

| | |
|---|---|
| MUSIM-Gap-r18 ::= | SEQUENCE { |

| | |
|---|---|
| musim-Gap-R18 | MUSIM-Gap-r17, |
| musim-GapPriorityEvent | GapPriorityEvent-R18 |
| musim-GapPriority-R18 | GapPriority-R17 |

| ... ... | |
|---|---|
| , | |
| } | |
| GapPriorityEvent-R18 ::= | CHOICE { |

| | |
|---|---|
| MeasObjectNR | MeasObjectNR, |
| lowMobilityEvaluation | relaxedMeasurement-r16 |
| cellEdgeEvaluation | cellEdgeEvaluation-r16 |

... ...
}

As seen above, the item “musim-GapPriorityEvent” specifies or defines the events which may be associated with the gap and can be utilized for updating of the priority of gap, and its contents or presentation can be shown in “GapPriorityEvent-R18”, which defines at least one events associated with the gap as well as the specifications related to respective events. In some embodiments, for an event, its corresponding specification may define some contents related to triggering of the operation for the gap, such as, parameter or object or characteristic index need to be detected or measured, corresponding evaluation manner or threshold, condition or related processing for the event, so that in the process, such contents can be utilized to judge the condition or status of the event.

For example, an event “MeasObjectNR” as well as its related specification “MeasObjectNR” are included, and the specification “MeasObjectNR” may include the measurement object and measurement parameter, for example, UE's location, UE's distance to some reference. For the event “lowMobilityEvaluation”, its corresponding specification “relaxedMeasurement-r16” may define UE's mobility as detection object, and a related mobility threshold, for evaluating whether the mobility is low. For the event “cellEdgeEvaluation”, its corresponding specification “cellEdgeEvaluation-r16” may define cell edge or relative distance to the cell edge as detection object, and a related threshold, for evaluating whether it is close to the cell edge.

Then, the event can be checked/detected according to the event configuration as above, for example, the event configuration provided in MUSIM-GapConfig as above.

In particular, in accordance with the event configuration, for a gap, its associated events can be detected or measured. In particular, for an event, the related parameter or object or characteristic index as indicated in the event configuration as above can be detected or measured. For example, for the event “LowMobilityEvalution”, the Mobility will be detected or measured.

Then, it is judged whether the detection or measurement result satisfies a predetermined condition, and once the condition in the event is met, the priority of the associated gap can be updated dynamically. On the other hand, the priority of the associated gap can be unchanged, or set to any appropriate value. For example, the information “musim-GapPriority-R18” can be handled in accordance with the detection or measurement result of the events indicated in the information “musim-GapPriorityEvent” accordingly.

For example, for an event “MeasObjectNR” which may relate to NR Handover, the related parameter or object or characteristic index intended to be detected may include that which can reflect the possibility of Handover, for example, the position of the wireless device in a cell, or the distance from the wireless device to the cell edge, etc, and then such detected parameter or index can be utilized to judge whether the Handover would be triggered. In particular, the distance can be compared with a distance threshold, and if the distance is smaller than the distance threshold, which means the wireless device is too near the cell edge and the Handover is intended to be performed, and thus the priority of gap associated with the event would be increased. Otherwise, the priority of gap can be remained unchanged, or set as another priority.

For example, an alternative MUSIM-GapConfig can be as follows.

| | |
|---|---|
| MUSIM-Gap-r18 ::= | SEQUENCE { |

| | |
|---|---|
| musim-Gap-R18 | MUSIM-Gap-r17, |
| musim-GapPriorityEvent | GapPriorityEvent-R18 |
| musim-GapPriorityDefault-r18 | GapPriority-r17, |
| musim-GapPriorityEvent-r18 | GapPriority-r17, |

| } | |
|---|---|
| GapPriorityEvent-R18 ::= | CHOICE { |

| | |
|---|---|
| MeasObjectNR | MeasObjectNR, |
| lowMobilityEvaluation | relaxedMeasurement-r16 |
| cellEdgeEvaluation | cellEdgeEvaluation-r16 |

}

Wherein, for the event indicated in the information “musim-GapPriorityEvent”, priority of gap associated with the event can be updated based on the detection or measurement result of the event, and depending on whether the detection or measurement result of the event satisfies a specific condition, the priority of gap can be set different values, such as indicated in “musim-GapPriorityEvent-r18” or “musim-GapPriorityDefault-r18”. For example, when conditions in GapPriorityEvent are not met, the priority equals to musim-GapPriorityDefault-r18, while when conditions in GapPriorityEvent are met, the priority equals to musim-GapPriority Event-r18.

In another example, the threshold for comparison can include at least one threshold, and for each threshold, corresponding priority can be set. For example, for the distance to be measured for the above event “MeasObjectNR”, there may exist at least two threshold, and the measured distance can be compared with each threshold so as to judge which threshold the distance is closest to and smaller than, and then the priority of the gap is set accordingly.

Note that the above MUSIM-CapConfig is only example, and such MUSIM-CapConfig can be in any other appropriate format, for example, may further include some other information, or the information therein, such as GapPriorityEvent, can include more or less elements. For example, GapPriorityEvent may only include one event depending on 3GPP progress, such as any one of the events as described above.

According to some embodiments of the present application, the updating of priority can be performed periodically or upon request. In one implementation, the event detection or measurement as described above can be performed periodically and whenever event detection or measurement is performed, the priority of gap will be updated based on the event detection or measurement result, such as when the condition in the event is met, the priority of gap can be changed, such as increased or decreased, otherwise, the priority of gap can be unchanged, or set to a specific value. Note that the periodicity of the priority updating may be the same as or different from the periodicity of the gap. And when their periodicities are different, after the priority of gap is updated, the updated priority can be stored temporarily and then will be utilized in the following gap occasion to improve the operation in the gap. And when their periodicities are same, the priority of gap can be first updated, and then the updated priority can be utilized in the present gap occasion to improve the operation in the gap.

In an example, when there exists at least one gap, there may exist at least one priority updating each corresponding to one gap, and the periodicity of the priority updating may be the same as or different from that of the corresponding gap. In another example, even when there exists at least one gap, one priority updating process is common for all the gap.

Note that the above updating of priority of gap can be performed by any appropriate object in the system. In particular, the above updating of priority of gap can be updated by the network side device, such as base station, and/or can be dynamically changed by the wireless device, such as the terminal side device, such as UE, and/or other device in the system

According to some embodiments, the event can be detected by the wireless device, particularly UE, and the detection result can be reported to the network side device, so that the network side device can change the priority for each gap at appropriate time. For example, the network side device can perform such change of priority periodically, or can upon request, such as when receiving the detection result.

According to some embodiments, the event can be detected by the wireless device, particularly UE, and then the UE can change the gap priority based on the event detection result. More specifically, the UE can change the gap priority once the event detection result is beyond the threshold. In another example, the UE can change the gap priority periodically, such as at predetermined intervals. In such a case, if the timing for changing the gap priority has not yet reached, the event detection result will be stored, and when the timing is reached, the latest event detection result included in the stored detection results will be utilized to judge whether the gap priority will be changed or not.

Finally and optionally, the updated priorities of gaps can be communicated in the system, and particularly, the entity updating the priorities of gaps can notify the updated priorities to other associated entity in the system, by means of any appropriate communication protocol or signaling.

Note that the above embodiments related to gap priority change according to the present disclosure are only exemplary, and the concept of the present disclosure can be equivalently applied to other kinds of gaps.

For example, the above embodiments can be extended to cover other types of gaps, including but not limited to Pre-configured measurement gap (Pre-MG), Network controlled small gap (NCSG), Gap for Non-Terrestrial Network (NTN gap), Gap for positioning (PosGap), and so on. And for each type of gap, its corresponding gap configuration can be set and its gap priority can be updated as discussed above, which will not be described in detail herein.

According to some embodiments, the information indicating whether the updating of priority of gap is supportable can be set and transmitted in the system. In particular, such information can be set for each type of gap separately and independently, or can be set for all types of gaps commonly. In an example, such information can be set at any appropriate stage in the communication, such as initialization, upon cell switching/access, upon status transition, staring of measurement operation, etc., and can be reported to the network device and/or the wireless device via any appropriate signaling, such as RRC signaling. In another example, such support information can be default set, such as during initialization.

According to some embodiments, the support information and/or the gap configuration and/or updated priority information can be communicated between the network-side device and the wireless device in a variety of manners. In an example, such communication can be performed via RRC signaling, for example, the measurement gap pattern support information and/or the gap (MG) configuration can be communicated via RRC layer.

Embodiments contemplated herein include an apparatus comprising means to perform one or more elements of the method for configuring and/or updating priority of gap at the wireless device side. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method at the wireless device side according to some embodiments of the present disclosure. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method at the wireless device side according to some embodiments of the present disclosure. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method at the wireless device side according to some embodiments of the present disclosure. This apparatus may be, for example, an apparatus of a UE (such as a wireless device 202 that is a UE, as described herein).

Embodiments contemplated herein include a signal as described in or related to one or more elements of the method at the wireless device side according to some embodiments of the present disclosure.

Embodiments contemplated herein include a computer program or computer program product comprising instructions, wherein execution of the program by a processor is to cause the processor to carry out one or more elements of the method at the wireless device side according to some embodiments of the present disclosure. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method for configuring and/or updating priority of gap at the network device according to embodiments of the present disclosure. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method at the network device according to embodiments of the present disclosure. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method at the network device according to embodiments of the present disclosure. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method at the network device according to embodiments of the present disclosure. This apparatus may be, for example, an apparatus of a base station (such as a network device 218 that is a base station, as described herein).

Embodiments contemplated herein include a signal as described in or related to one or more elements of the method at the network device according to embodiments of the present disclosure.

Embodiments contemplated herein include a computer program or computer program product comprising instructions, wherein execution of the program by a processing element is to cause the processing element to carry out one or more elements of the method at the network device according to embodiments of the present disclosure. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

In the following further exemplary embodiments are provided.

One set of embodiments may include a wireless device comprising at least one antenna; at least one radio coupled to the at least one antenna; and a processor coupled to the at least one radio; wherein the processor is configured to: acquire a gap configuration scheduling operation of the wireless device in accordance with gap patterns, wherein the gap configuration includes priority information related to a priority for each of multiple gaps, and perform operation based on the gap patterns, wherein the operation is performed based on the priorities of the gap patterns.

According to some embodiments, the processor is further configured to: when at least two of the multiple gaps collide, perform operation based on the gap pattern of a gap in the at least two gaps with the highest priority.

According to some embodiments, the processor is further configured to: perform dynamically updating of priority of a gap in the multiple gaps based on detection result of a specific event corresponding to the gap.

According to some embodiments, the processor is further configured to: transmit the updating result of priority of the gap to the network device.

According to some embodiments, the processor is further configured to: detect a specific event corresponding to a gap in the multiple gaps, and dynamically update the priority of the gap when it is detected that condition in the specific event is met.

According to some embodiments, the processor is further configured to: when it is detected that the condition in the specific event is not met, set the priority of the gap to a specific priority value or do not change the priority of the gap.

According to some embodiments, the specific priority value is a default priority value or the previous priority value.

According to some embodiments, the processor is further configured to: perform the event detection periodically or upon request.

According to some embodiments, the processor is further configured to: detect a specific event corresponding to a gap in the multiple gaps, and transmit the detection result of the specific event to a network device, and receive the updated priority from the network device which is obtained by updating the priority of the gap when the condition in the event is met.

According to some embodiments, the gap configuration is related to MUSIM gap.

Another set of embodiments may include a network device, comprising: at least one antenna; at least one radio coupled to the at least one antenna; and a processor coupled to the at least one radio; wherein the processor is configured to: acquire a gap configuration scheduling operation of the wireless device in accordance with gap patterns, wherein the gap configuration includes priority information related to a priority for each of multiple gaps, and provide the gap configuration information to the wireless device.

According to some embodiments, the processor is further configured to: configure events and corresponding gap priorities for the multiple gaps in the gap configuration.

According to some embodiments, the processor is further configured to: receive updated priority for a gap from the wireless device, which is obtained by updating the priority of the gap when a condition in an event corresponding to the gap is met.

According to some embodiments, the processor is further configured to: receive the detection result of a specific event corresponding to a gap from the wireless device, dynamically update the priority of the gap when it is detected that the condition in the specific event is met, and transmit the updated priority to the wireless device.

According to some embodiments, the gap configuration is related to MUSIM gap.

Yet another set of embodiments may include an apparatus, comprising: a processor configured to cause a wireless device to: acquire a gap configuration scheduling operation of the wireless device in accordance with gap patterns, wherein the gap configuration includes priority information related to a priority for each of multiple gaps, and perform operation based on the gap patterns, wherein the operation is performed based on the priorities of the gap patterns.

According to some embodiments, the processor can cause the wireless device to implement any or all parts of any of the preceding embodiments/examples.

Yet another set of embodiments may include an apparatus, comprising: a processor configured to cause a network device to acquire a gap configuration scheduling operation of the wireless device in accordance with gap patterns, wherein the gap configuration includes priority information related to a priority for each of multiple gaps, and provide the gap configuration information to the wireless device.

According to some embodiments, the processor can cause the network device to implement any or all parts of any of the preceding embodiments/examples.

Yet another set of embodiments may include a method for a wireless device, comprising: acquiring a gap configuration scheduling operation of the wireless device in accordance with gap patterns, wherein the gap configuration includes priority information related to a priority for each of multiple gaps, and performing operation based on the gap patterns, wherein the operation is performed based on the priorities of the gap patterns.

According to some embodiments, the method can be further performed by the wireless device to implement any or all parts of any of the preceding embodiments/examples.

Yet another set of embodiments may include a method for a network device, comprising: acquiring a gap configuration scheduling operation of the wireless device in accordance with gap patterns, wherein the gap configuration includes priority information related to a priority for each of multiple gaps, and providing the gap configuration information to the wireless device.

According to some embodiments, the method can be further performed by the network device to implement any or all parts of any of the preceding embodiments/examples.

Yet another set of embodiments may include a device comprising: a processor, and a computer-readable storage medium, having program instructions stored thereon, which, when executed, cause the processor to implement any or all parts of any of the preceding method embodiments.

Yet another set of embodiments may include a computer-readable storage medium, having program instructions stored thereon, which, when executed, cause the processor to perform any or all parts of any of the preceding method embodiments.

Yet another set of embodiments may include a computer program product comprising program instructions, which, when executed by a computer, cause a computer to perform any or all parts of any of the preceding method embodiments.

Yet another set of embodiments may include a computer program comprising program instructions, which, when executed by a computer, cause a computer to perform any or all parts of any of the preceding method embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device, comprising:
at least one antenna;
at least one radio coupled to the at least one antenna; and
a processor coupled to the at least one radio;
wherein the processor is configured to:
acquire a gap configuration scheduling operation of the wireless device in accordance with gap patterns, wherein the gap configuration includes priority information related to a priority for each of multiple gap patterns, and
perform operation based on the gap patterns, wherein the operation is performed based on the priorities of the gap patterns.

2. The wireless device of claim 1, wherein the processor is further configured to:
when at least two of the multiple gaps collide, perform operation based on the gap pattern of a gap in the at least two gaps with the highest priority.

3. The wireless device of claim 1, wherein the processor is further configured to:
perform dynamically updating of priority of a gap pattern in the multiple gap patterns based on detection result of a specific event corresponding to the gap pattern.

4. The wireless device of claim 3, wherein the processor is further configured to:
transmit the updating result of priority of the gap to the network device.

5. The wireless device of claim 1, wherein the processor is further configured to:
detect a specific event corresponding to a gap pattern in the multiple gap patterns, and
dynamically update the priority of the gap pattern when it detects that condition in the specific event is met.

6. The wireless device of claim 1, wherein the processor is further configured to:
when it detects that the condition in the specific event is not met, set the priority of the gap to a specific priority value or do not change the priority of the gap.

7. The wireless device of claim 6, wherein the specific priority value is a default priority value or the previous priority value.

8. The wireless device of claim 7, wherein the processor is further configured to:
perform the event detection periodically or upon request.

9. The wireless device of claim 1, wherein the processor is further configured to:
detect a specific event corresponding to a gap pattern in the multiple gap patterns, and transmit the detection result of the specific event to a network device, and
receive the updated priority from the network device which is obtained by updating the priority of the gap when the condition in the event is met.

10. The wireless device of claim 9, wherein the gap configuration is related to MUSIM gap.

11. A network device, comprising:
at least one antenna;
at least one radio coupled to the at least one antenna; and
a processor coupled to the at least one radio;
wherein the processor is configured to:
acquire a gap configuration scheduling operation of the wireless device in accordance with gap patterns, wherein the gap configuration includes priority information indicating a priority for each of multiple gaps, and
provide the gap configuration to the wireless device.

12. The network device of claim 11, wherein the processor is further configured to:
configure events and corresponding gap pattern priorities for the multiple gap patterns in the gap configuration.

13. The network device of claim 11, wherein the processor is further configured to:
receive updated priority for a gap pattern from the wireless device, which is obtained by updating the priority of the gap pattern when a condition in an event corresponding to the gap pattern is met.

14. The network device of claim 13, wherein the processor is further configured to:
acquire the detection result of a specific event corresponding to a gap pattern from the wireless device,
dynamically update the priority of the gap pattern when it is detected that the condition in the specific event is met, and
transmit the updated priority to the wireless device.

15. The network device of claim 14, wherein the gap configuration is related to MUSIM gap.

16. An apparatus, comprising:
a processor configured to cause a wireless device to:
acquire a gap configuration scheduling operation of the wireless device in accordance with gap patterns, wherein the gap configuration includes priority information related to a priority for each of multiple gaps, and
perform operation based on the gap patterns, wherein the operation is performed based on the priorities of the gap patterns.

17-22. (canceled)
